(19) United States
(12) Patent Application Publication
(10) Pub. No.: US 2012/0068677 A1
(43) Pub. Date: Mar. 22, 2012

(54) RESONANT POWER CONVERTER DRIVING AN INDUCTIVE LOAD LIKE A DISCHARGE LAMP

(75) Inventors: Machiel A.M. Hendrix, Eindhoven (NL); Thomas Gerrits, Eindhoven (NL)

(73) Assignee: KONINKLIJKE PHILIPS ELECTRONICS N.V., EINDHOVEN (NL)

(21) Appl. No.: 13/321,227

(22) PCT Filed: May 18, 2010
(86) PCT No.: PCT/IB2010/052201

§ 371 Date: Nov. 18, 2011

(30) Foreign Application Priority Data
May 20, 2009 (EP) 09160722.6

(51) Int. Cl. G05F 3/08

(52) U.S. Cl. 323/271

(57) ABSTRACT

A resonant power converter (1) for driving an inductive load as, e.g. an inductively coupled gas-discharge lamp, is designed for operation at an operational frequency (Fop) of 13.56 MHz and comprises: a series arrangement of a first inductor (L1) and a first controllable switch (Q1) connected to a DC voltage source (DC);-a series arrangement of a second inductor (L2) and a second controllable switch (Q2) connected to said DC voltage source (DC); a first parallel capacitance (Cds1) associated with the first controllable switch (Q1); a second parallel capacitance (Cds2) associated with the second controllable switch (Q2); a controller (30) for driving the switches (Q1, Q2); the load is coupled between said nodes (A, B); the switches alternate between a conductive state and a non-conductive state at a duty cycle of 50%;-the switching frequency (Psw) is one-third of said operational frequency (Fop).

### FIELD OF THE INVENTION

The present invention relates in general to a power converter suitable for driving an inductive load at high frequencies. The present invention relates particularly to a driver for an inductively coupled gas-discharge lamp.

### BACKGROUND OF THE INVENTION

For driving an inductive load, a class-E amplifier has a suitable design, basically capable of operating at a high operating frequency with a high efficiency. Its basic design is shown in FIG. 1. A main inductor L1 is connected in series with a controllable switch Q1; the node between L1 and Q1 is indicated as first node A. The switch is typically implemented as a MOSFET. The free terminal of the inductor L1 is connected to a positive terminal of a DC power source, and the free terminal of the switch Q1 is connected to the negative terminal of this power source. Cds1 indicates a capacitance in parallel to the first switch Q1; it typically includes the non-linear parasitic drain-source capacitance of the MOSFET Q1 as well as a parallel arranged external capacitor, having capacitance much higher than the said non-linear parasitic drain-source capacitance in order to reduce the influence of the non-linear parasitic drain-source capacitance as much as possible. A load 10 is shown to comprise a series combination of a load resistance 11 and a load inductance 12. Between first node A and a first input terminal 13 of the load 10, a series arrangement of a series capacitor Cs1 and a series inductor Ls1 is connected. The load 10 has its second terminal 14 connected to the negative power terminal. The inductance of the inductor L1 has such a high value that the input at node A can be considered as being a constant current source.

The device has a resonance frequency determined by the series capacitor Cs1 and series inductor Ls1. In operation, the switch Q1 is switched ON and OFF with a duty cycle of 50%, wherein the switching frequency is close to the resonance frequency. With a good design of the components and their layout, the amplifier can have very low losses and thus a very high efficiency, up to over 80%. It is noted that a proper design at least includes Zero Voltage Switching and Zero Derivative Switching, as should be known to a person skilled in this art.

When high power is desirable, it is preferred to use a symmetrical push-pull design, as illustrated in FIG. 2. Such a push-pull design is for instance disclosed in the article “Idealized Operation of the Class E Tuned Power Amplifier” by Frederick H. Raab in IEEE TRANSACTIONS ON CIRCUITS AND SYSTEMS, VOL. CAS-24, NO. 12, DECEMBER 1977, p. 725. In such a push-pull design, the amplifier comprises a second series arrangement of a second main inductor L2 and a second controllable switch Q2 connected between the positive and negative supply terminals; the node between L2 and Q2 is indicated as second node B. Cds2 indicates a capacitance in parallel to the second switch

Q2; it typically includes the non-linear parasitic drain-source capacitance of the MOSFET Q2 as well as a parallel arranged external capacitor, having capacitance much higher than the said parasitic drain-source capacitance in order to reduce the influence of the non-linear parasitic drain-source capacitance as much as possible. The load 10 has its second terminal coupled to second node B with, for reasons of symmetry, a second series arrangement of a second series capacitance Cs2 and a second series inductance Ls2 connected between second node B and load 10.

In this standard design, the second switch Q2 is controlled with a 180° phase difference with respect to the first switch Q1.

### SUMMARY OF THE INVENTION

In commercial lamp drivers, it is desirable to have cheap components. In normal, commercially available switches, the gate capacitance and resistance have a substantial value, which leads to a loss of power, which loss is proportional to the switching frequency. There is a general desire to increase the overall efficiency of electric and electronic apparatus as much as possible, in other words to reduce power losses as much as possible. Therefore, it is an objective of the present invention to improve the above-described class-E power amplifier design so as to provide a cost-effective converter potentially capable of having increased efficiency.

According to an important aspect, the present invention deviates from the design rule that the switching frequency should be close to the output frequency. In contrast, the present invention proposes that the output frequency is three times the switching frequency. As a result, the switching frequency is reduced when the output frequency is maintained, resulting in a reduction of the power loss in the switching stage.

Further advantageous elaborations are mentioned in the dependent claims.

### BRIEF DESCRIPTION OF THE DRAWINGS

These and other aspects, features and advantages of the present invention will be further explained by the following description of one or more preferred embodiments with reference to the drawings, in which same reference numerals indicate same or similar parts, and in which:

FIG. 1 schematically shows a basic diagram of a single-ended class-E amplifier;

FIG. 2 schematically shows a basic diagram of a push-pull class-E converter;

FIG. 3 schematically shows a diagram of a push-pull converter according to the present invention, for the case of a load such as a lamp having a sufficiently high inductance;

FIG. 4 is a schematic top view showing the topographic layout of components of the push-pull converter according to the present invention on a PCB;

FIG. 5 is a graph showing measured experimental results of the efficiency of the push-pull converter according to the present invention;

FIGS. 6 and 7 show graphs illustrating the tolerances of different embodiments.

### DETAILED DESCRIPTION OF THE INVENTION

For driving an inductively coupled gas discharge lamp, a suitable output frequency with respect to on the one hand discharge efficiency and on the other hand EMI/EMC restrictions is 13.56 MHz.

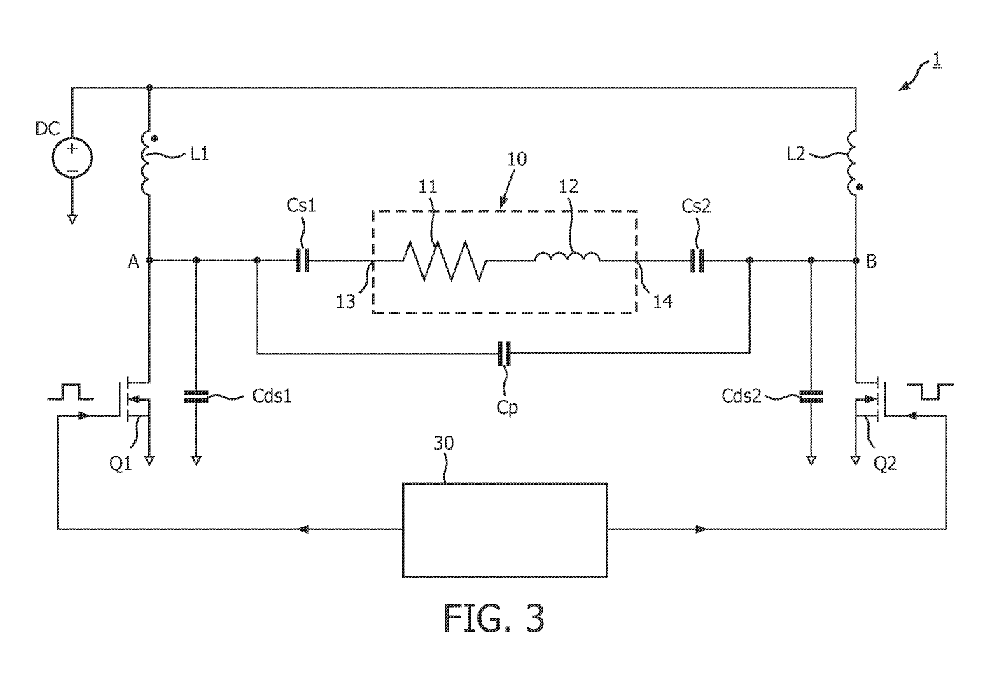

Typically, in the case of a gas discharge lamp, the inductance of the load is high enough, so that Ls1 and Ls2 can be omitted. The resulting circuit 1 is shown in FIG. 3. Cp indicates the, in a physical circuit unavoidable, added parallel filter capacitance between node A and node B. The capacitance Cp can be thought to be absorbed in the capacitances Cds1 and Cds2.

A controller for controlling the switches Q1 and Q2 is indicated at 30. The controller 30 generates control signals for the switches Q1 and Q2 such that each switch is switched ON and OFF at a switching frequency that is a factor three lower than the desired output frequency, i.e. the switching frequency is equal to 4.52 MHz. This ON/OFF switching results in a current signal that can be approximated by a square wave signal, or, if the finite rise time and fall time of the signal edges for avoiding switching losses are taken into account, a trapezium wave signal, which involves a frequency spectrum having a large content of the third harmonic frequency.

It is noted that the circuit comprises two resonance circuits with two different resonance frequencies, assuming that the circuit is symmetrical. One resonance is the series resonance provided by the load 10 in conjunction with the series capacitors Cs1 and Cs2. The other resonance is the parallel resonance provided by the main inductor L1 and the drain capacitance Cds1 of the corresponding switch Q1. It is noted that a similar resonance is the parallel resonance provided by the second main inductor L2 and the drain capacitance Cds2 at the second switch Q2, but in the case of a good, symmetrical design of the circuit this second parallel resonance has the same parallel resonance frequency. It is possible, of course, to calculate the series resonance frequency and the parallel resonance frequency of the separate circuits. However, said resonance circuits influence each other, and it is difficult and not particularly enlightening, to give a general formula expressing the overall resonance frequency of the entire circuit 1 as a function of said two resonance frequencies, as should be clear to a person skilled in the art.

For obtaining an output frequency of 13.56 MHz, an intuitive approach might be to tune the series resonance circuit and the parallel resonance circuit to this frequency. However, the parallel resonance circuit has a very high (theoretically infinite) impedance at its resonance frequency, and if a series resonance circuit, tuned for the same frequency, is connected to this parallel resonance circuit, it does not filter anything. This is undesirable as it is intended that these circuits form a band-pass filter for the third harmonic of the switching frequency.

Inventor has found that a proper design of the circuit 1 involves a series resonance frequency close to (but not equal to) the desired output frequency of 13.56 MHz, and a parallel resonance frequency in the order of about 8 MHz.

Cs1 and Cs2 are adapted to set the series resonance frequency substantially equal to the desired value.

The inductances of the main inductor L1 [and L2] are chosen such that the parallel resonance frequency of the circuit L1/Cds1 [and L2/Cds2] is substantially equal to the desired value.

Inventor has found, by simulation and calculation, that, for the case of a 300 W inductive lamp having an inductance of 2.2 pH, optimum values for the several components are as follows:

L1=L2=550 nH

Cds1=Cds2=600 pF

Cs1=Cs2=66 pF

The inventor has found that a careful design of the main inductors L1 and L2 is important in achieving an efficiency as high as possible. This relates to the design of the individual inductors as well as to the physical arrangement of the inductors with respect to each other in the actual device.

When designing an individual inductor, important boundary conditions are the size of the inductor, low loss, and low external magnetic field, apart from the inductance value. In a test design suitable for a 300 W converter, it was calculated that the inductor should have an inductance of 550 nH. The inductor was designed to have 7 windings of thin copper strip in a toroid shape. The strip had a width of 6.35 mm and a thickness of 127 μm; this minimizes the losses due to the skin effect, considering that the skin depth was calculated to be about 31 μm. The core body of the coil, made from a non-ferro material so that the core can be considered to be an air core, had a cylindrical shape with an outer diameter of 50 mm, an inner diameter of 20 mm, and a height of 42 mm.

It is noted that small variations are possible; nevertheless, the described design is considered to be an optimal compromise. If the inner diameter is reduced, the distance between two adjacent windings in the inner space of the toroid is reduced so that the influence of proximity losses increases. If the inner diameter is increased, the surface area surrounded by each winding is reduced, which should be compensated by increasing the height and/or the outer diameter. Likewise, if the number of windings is increased, the distance between two adjacent windings in the inner space of the toroid is reduced, whereas, if the number of windings is decreased, the surface area should be increased. Likewise, if the width of the copper strip is increased, the influence of proximity losses increases, whereas, if the width of the copper strip is decreased, the Ohmic resistance of the inductor increases. Further, it is possible to use a magnetic material for the core body, but it was found that such coil designs would have higher internal losses.

Each inductor unavoidably has some stray magnetic field. For optimum operation, it is desirable that the magnetic coupling to the other circuit components is minimized as much as possible. In a practical device, however, the distance between the coils and the other components cannot be selected higher at will: the length of the connecting wires and the overall bulkiness of the device must remain within limits. In order to minimize the magnetic coupling to the other circuit components in the case of a push-pull converter, having two coils, the invention proposes that, when the two coils are arranged close together, special measures are taken.

The inventor has found that, for optimum operation, the exact inductance values of the coils are important. When the two coils are arranged close together, they have a mutual magnetic coupling, which will effectively change their inductance values.

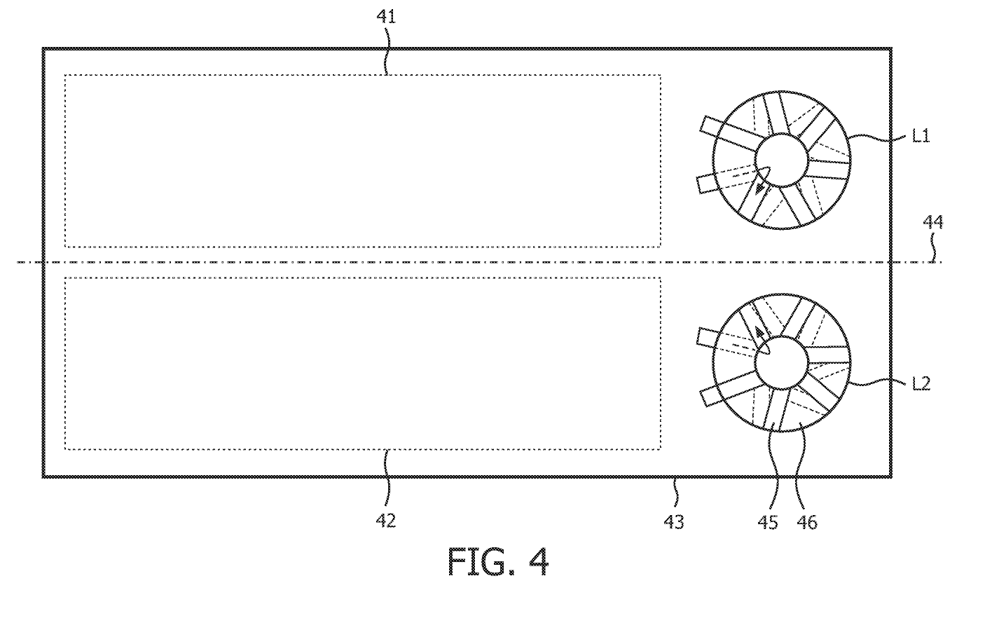

In order to reduce these problems, the invention proposes that the layout of the circuit components in the practical realization is made as symmetric as possible. FIG. 4 is a schematic top view of a PCB 43, schematically showing the topographical location 41 of the components on one side of the load, i.e. Q1 etc., and the topographical location 42 of the components on the other side of the load, i.e. Q2 etc. The figure shows that the arrangement is mirror-symmetrical with respect to a centre plane 44. This does not only relate to the positioning as such. As regards location on the PCB, the two coils L1 and L2 are arranged symmetrically with respect to this centre plane 44, adjacent to the corresponding topographical locations 41, 42, with their central axes parallel to the centre plane 44 and perpendicular to the carrier PCB 43. Furthermore, the two coils L1, L2 are not mutually identical but they are wound mirror-symmetrically, and their physical orientation with respect to their individual central axes, i.e. their angular orientation, is such that their individual windings are actually located mirror-symmetrically with respect to each other, as schematically indicated by arrows.

Furthermore, the two coils are electrically connected in mutually opposite manner, as indicated by dots in FIG. 3.

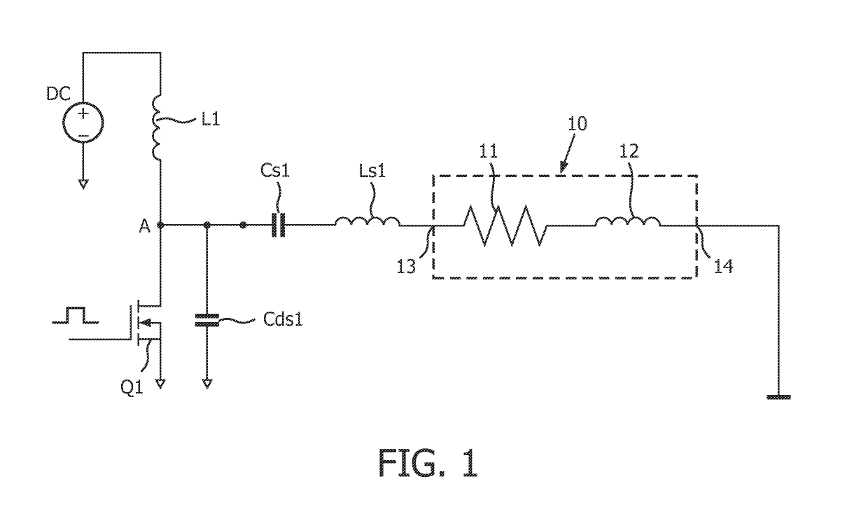

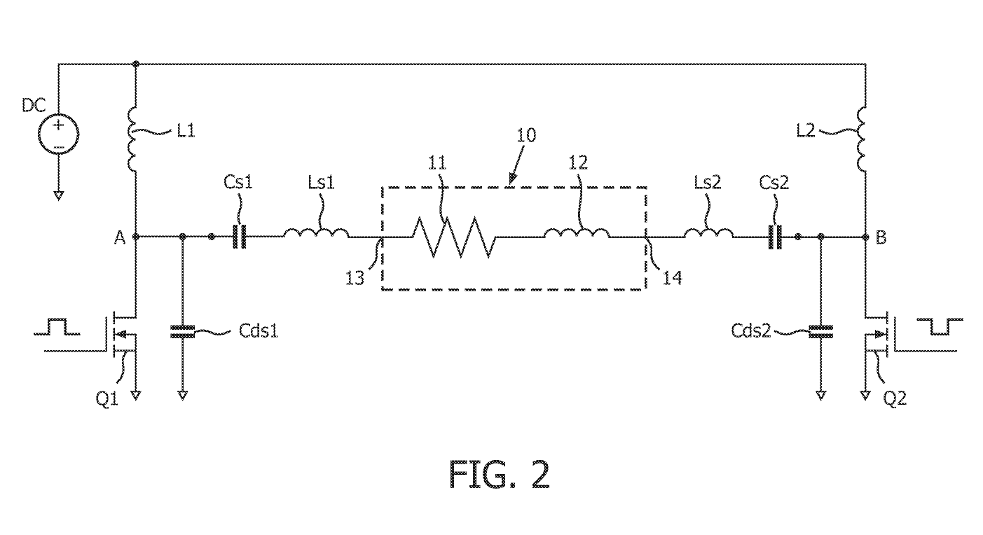

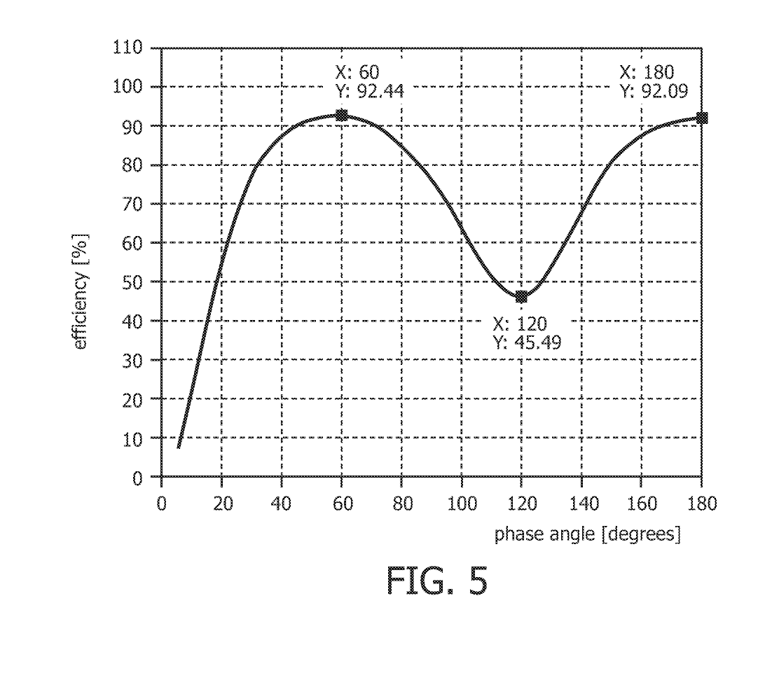

In the case of a single-ended design (see FIG. 1), there obviously is only one switch. Such single-ended design is an embodiment of the present invention. However, in the preferred push-pull embodiment (FIG. 3), there are two switches Q1 and Q2. In the standard class-E amplifier (FIG. 2), the controller 30 would generate its control signals for the two switches Q1 and Q2 such that there is a phase difference of 180° between these two switches, i.e. these switches are alternatively ON/OFF and OFF/ON, respectively. However, the present inventor has realized that in the proposed design of FIG. 3, with the proposed use of the third harmonic of the switching frequency, it is possible to use a phase difference differing from 180°, and the inventor has investigated the influence of this phase difference. A prototype of the converter was built in accordance with the above parameters. The phase difference between the control signals for the two switches Q1 and Q2 was varied, and the resulting efficiency was measured. FIG. 5 is a graph showing the results, for the phase difference between zero and 180° (it is noted that the circuit is symmetrical). The horizontal axis shows the phase difference in degrees, while the vertical axis shows the efficiency (output power versus input power) in percent. For the “normal” phase difference of 180° it was found that the efficiency was as high as 92.09%. Surprisingly, it was found that the efficiency was even slightly higher (92.44%) at a phase difference of 60°. Although this only seems like a small improvement, it is nevertheless important. For an individual 300 W lamp, it involves a reduction of power loss by 2.3 W.

It is noted that the improvement offered by this aspect of the present invention is not only offered at a phase difference of exactly 60°. The local maximum at 60° is relatively broad, so that for a certain range of phase differences around 60° the efficiency is actually higher than at 180°; for instance, at a phase difference of 54° the efficiency was still found to be 92.16%. Further, it is noted that the exact maximum is achieved at a phase difference slightly lower than 60°, but this is considered to be due to imperfections in the test circuit.

An embodiment within the scope of the present invention involves a phase difference equal to 180° or in a range close to 180°. From FIG. 5 it can be seen that the efficiency maximum is relatively broad: for a range from about 165° to about 195°, the efficiency is at least higher than 90%, in other words the efficiency drops by about 2% if the phase difference is increased/decreased by about 8%.

Unexpectedly, the inventor has found that an embodiment with a phase difference equal to 60° or in a range close to 60° even has a better efficiency. For a range from about 45° to about 70°, the efficiency is at least higher than 90%, in other words the efficiency drops by about 2% if the phase difference is increased/decreased by about 20%.

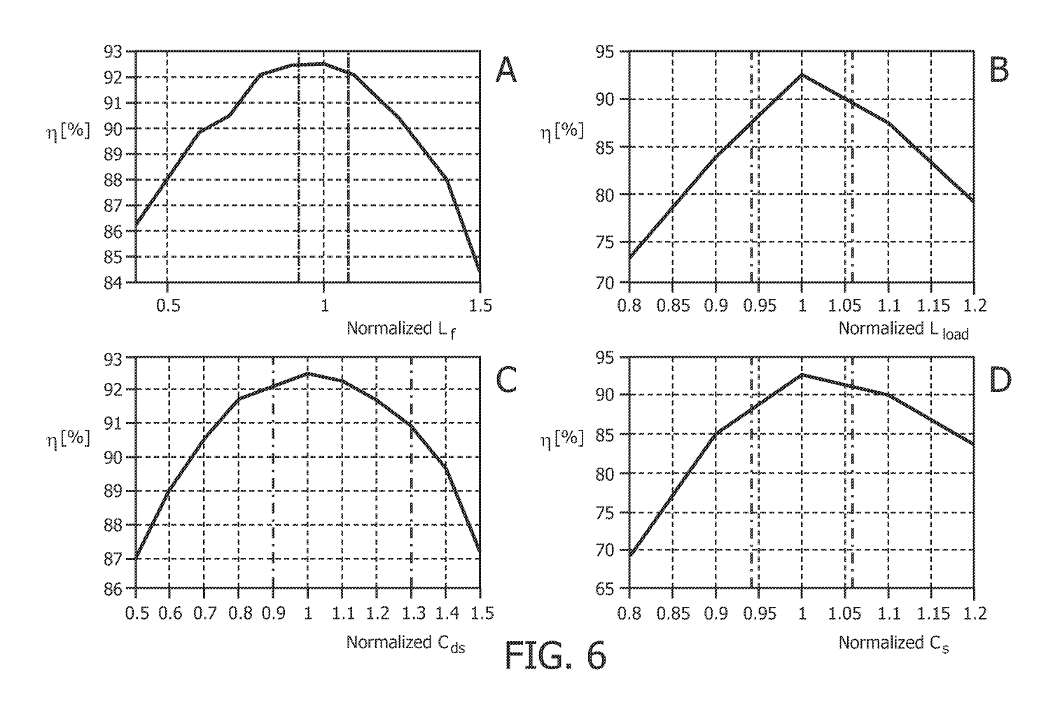

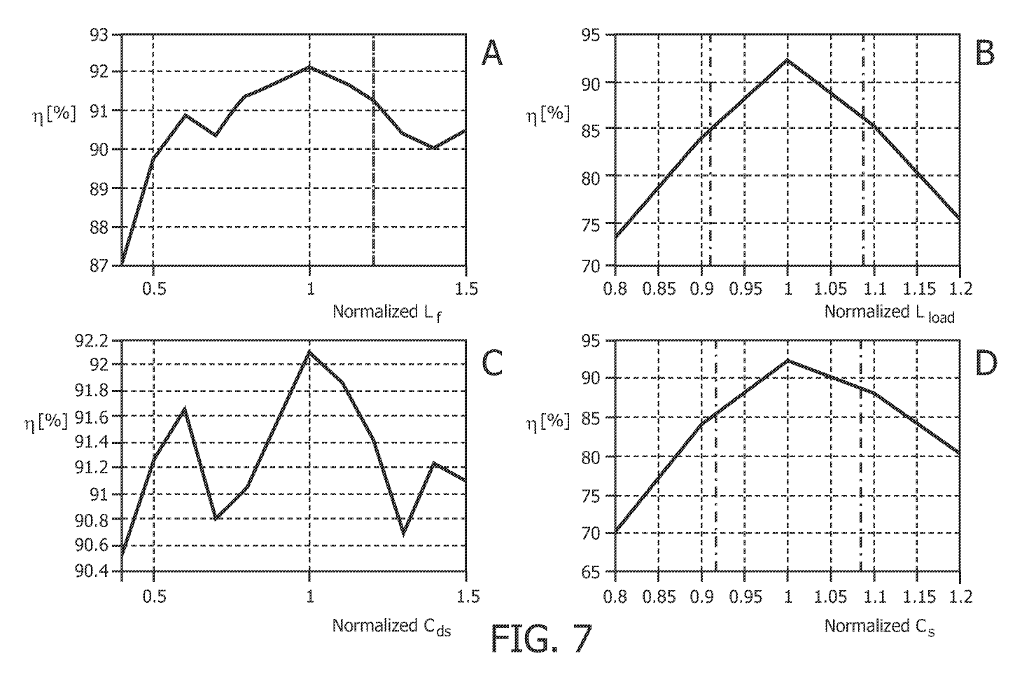

The inventor has investigated the sensitivity of the circuit to changing component values, in other words the tolerance of the components. FIG. 6 shows the results for the phase difference being set equal to 60°, and FIG. 7 shows the results for the phase difference being set equal to 180°. Each figure shows four graphs A, B, C, D corresponding to a certain component. In each graph, the vertical axis represents efficiency in percent (note the different scales, and note the position of the zero), and the horizontal axis represents component value normalized with respect to the values given above as being optimal. Vertical dotted lines indicate when the voltage drop over the switches would become too high (taken to be 83% of the allowable voltage specified by the manufacturer).

For instance, in FIG. 6, graph A shows that, for the phase difference being set equal to 60°, the main inductances L1 and L2 can be varied by about −20% to about +10% before the efficiency drops below 92%, but a practically available range is from about −8% to about +8%, with respect to the optimal value of 550 nH. For the phase difference being set equal to 180°, graph A of FIG. 7 shows that the voltage drop over the switch does not form an obstacle for varying the main inductances L1 and L2 in a wider range: the inductance can be increased by about 20%, and it seems that no restrictions are present when decreasing the inductance. However, this figure also shows that the efficiency drops much faster when the inductance is varied: when the main inductances L1 and L2 are increased or decreased by 10%, the efficiency has dropped to about 91.7%. Further, when the main inductances L1 and L2 are varied in the range from −10% to +10%, the efficiency at 60° is always higher than the efficiency at 180°.

Graphs B relate to the inductance of the load (i.e. lamp), the nominal optimal value being 2.2 μH. It can be seen that, for the phase difference being set equal to 180°, the available range for variation is wider as compared to the phase difference being set equal to 60°, as far as the limiting factor of the voltage drop over the switch is concerned: the load inductance may vary from about −8% to about +8% at 180° and may only vary from about −6% to about +6% at 60°. However, when the load inductance is varied from about −6% to about +6%, the efficiency at 60° is always higher than the efficiency at 180°.

Graphs C relate to the drain capacitances Cds1 and Cds2, the nominal optimal value being 600 pF. It can be seen that, for the phase difference being set equal to 180°, the voltage drop over the switch does not seem to provide any restrictions, whereas for the case of the phase difference being set equal to 60°, the capacitance should not vary by more than −10% or more than +30%. However, it can also be seen that the efficiency drops much faster in the case of the phase difference being set equal to 180° as compared to 60°. For the phase difference being set equal to 60°, the drain capacitances can be varied by about −10% to about +15% before the efficiency drops below 92%, whereas if, in the case of the phase difference being set equal to 180°, the drain capacitances are varied by about −10% or about +15%, the efficiency has dropped below 91.6%. For the entire range from about −10% to about +15%, the efficiency at 60° is always higher than the efficiency at 180°.

Graphs D relate to the series capacitances Cs1 and Cs2, the nominal optimal value being 66 pF. It can be seen that, for the phase difference being set equal to 180°, the available range for variation is wider as compared to the phase difference being set equal to 60°, as far as the limiting factor of the voltage drop over the switch is concerned: the load inductance may vary from about −8% to about +8% at 180° and may only vary from about −6% to about +6% at 60°. However, when the load inductance is varied from about −6% to about +6%, the efficiency at 60° is always higher than the efficiency at 180°.

Thus, the inventor has proven that, for a wide range of component tolerances, a phase difference of 60° provides for a better efficiency as compared to a phase difference of 60°.

Thus, the present invention provides a resonant power converter 1 for driving an inductive load, designed for operation at an operational frequency Fop of 13.56 MHz and comprising:

a series arrangement of a first inductor L1 and a first controllable switch Q1 connected to a DC voltage source DC;

a series arrangement of a second inductor L2 and a second controllable switch Q2 connected to said DC voltage source DC;

a first parallel capacitance Cds1 associated with the first controllable switch Q1;

a second parallel capacitance Cds2 associated with the second controllable switch Q2;

a controller 30 for driving the switches Q1, Q2;

the load is coupled between said nodes A, B;

the switches alternate between a conductive state and a non-conductive state at a duty cycle of 50%;

the switching frequency Fsw is one-third of said operational frequency Fop.

While the invention has been illustrated and described in detail in the drawings and foregoing description, it should be clear to a person skilled in the art that such illustration and description are to be considered illustrative or exemplary and not restrictive. The invention is not limited to the disclosed embodiments; rather, several variations and modifications are possible within the protective scope of the invention as defined in the appending claims.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

In the above, the present invention has been explained with reference to block diagrams, which illustrate functional blocks of the device according to the present invention. It is to be understood that one or more of these functional blocks may be implemented in hardware, where the function of such a functional block is performed by individual hardware components, but it is also possible that one or more of these functional blocks are implemented in software, so that the function of such a functional block is performed by one or more program lines of a computer program or a programmable device such as a microprocessor, microcontroller, digital signal processor, etc.

1. Resonant power converter (1) for driving an inductive load having a first input terminal (13) and a second input terminal (14), the converter being designed for operation at an operational frequency (Fop) of 13.56 MHz and comprising:
a series arrangement of a first inductor (L1) and a first controllable switch (Q1) connected to a DC voltage source (DC);
a series arrangement of a second inductor (L2) and a second controllable switch (Q2) connected to said DC voltage source (DC), wherein the second inductor (L2) is connected to the same voltage source terminal as the first inductor (L1);
a first parallel capacitance (Cds1) associated with the first controllable switch (Q1);
a second parallel capacitance (Cds2) associated with the second controllable switch (Q2);
a controller (30) for driving the switches (Q1, Q2);
wherein the first load input terminal (13) is coupled to the node (A) between the first inductor (L1) and the first controllable switch (Q1);
wherein the second load input terminal (14) is coupled to the node (B) between the second inductor (L2) and the second controllable switch (Q2);
wherein the controller (30) is designed to generate control signals for the first and second controllable switches (Q1, Q2) such that each controllable switch (Q1, Q2) alternates between a conductive state and a non-conductive state at a duty cycle of 50%;
wherein the controller (30) is designed to set the switching frequency (Fsw) of said switches (Q1, Q2) at one-third of said operational frequency (Fop) or at a value close to one-third of said operational frequency (Fop).

2. Converter according to claim 1, wherein the two inductors (L1, L2) are electrically connected in mutually opposite manner.

3. Converter according to claim 1, wherein the two inductors (L1, L2) are designed mirror-symmetrically with respect to each other, and are mounted on a carrier PCB (43) in a mirror-symmetric manner with respect to a centre plane (44) of the carrier PCB (43).

4. Converter according to claim 1, wherein each inductor (L1, L2) is constructed from thin copper strip (45) wound on a toriod-shaped plastic coil body (46), and wherein the two inductors (L1, L2) are mounted on a carrier PCB (43) with their central axes mutually parallel.

5. Converter according to claim 1, further comprising a first series capacitor (Cs1) connected in series between said first load input terminal (13) and said first node (A), and a second series capacitor (Cs2) connected in series between said second load input terminal (14) and said second node (B).

6. Converter according to claim 5, wherein the two series capacitor (Cs1, Cs2) have mutually substantially equal capacitance values, selected to set the series resonance frequency at a value close to said operational frequency.

7. Converter according to claim 6, wherein the two inductors (L1, L2) have mutually substantially equal inductance values, and wherein the two switches (Q1, Q2) have mutually substantially equal parallel capacitance values (Cds1, Cds2).

8. Converter according to claim 7, wherein the inductances of the two inductors (L1, L2) are selected to set the parallel resonance frequency of the circuits formed by the combination of inductor (L1; L2) and parallel capacitance (Cds1; Cds2) at a value in the order of about 8 MHz.

9. Converter according to claim 5, for a load having an inductance of 2.2 μH, wherein:
L1=L2=550 nH Cds1=Cds2=600 pF Cs1=Cs2=66 pF

10. Converter according to claim 1, wherein the controller (30) is designed to generate its control signals for the first and second controllable switches (Q1, Q2) with a mutual phase difference Δφ equal to 180° or close to 180°.

11. Converter according to claim 1, wherein the controller (30) is designed to generate its control signals for the first and second controllable switches (Q1, Q2) with a mutual phase difference Δφ equal to 60° or close to 60°.

12. Method for operating a converter according to claim 1, the method comprising the steps of
adapting the controller (30) to generate its control signals for the first and second controllable switches (Q1, Q2) with a certain mutual phase difference Δφ equal to 60° or close to 60°;
varying the phase difference Δφ in a small range around 60°, for each selected value of the phase difference Δφ determining the efficiency of the converter, and thus determining an optimum phase difference value in said range where the efficiency of the converter is highest;
adapting the controller (30) to generate its control signals for the first and second controllable switches (Q1, Q2) with a certain mutual phase difference Δφ equal to 180° or close to 180°;
varying the phase difference Δφ in a small range around 180°, for each selected value of the phase difference Δφ determining the efficiency of the converter, and thus determining an optimum phase difference value in said range where the efficiency of the converter is highest;
determining whether the maximum efficiency of the converter for the optimum phase difference value in said range around 60° is higher than the maximum efficiency of the converter for the optimum phase difference value in said range around 180°, and if so, operating the converter with the controller (30) adapted to generate its control signals for the first and second controllable switches (Q1, Q2) with said optimum phase difference value in said range around 60°.
